(19) United States
(12) Patent Application Publication
(10) Pub. No.: US 2020/0046582 A1
(43) Pub. Date: Feb. 13, 2020

(54) AUTOMATIC LOCKING MECHANISM FOR COLLAPSIBLE ELEMENTS

(71) Applicant: INSTITUCION UNIVERSITARIA SALAZAR Y HERRERA, Medellin (CO)

(72) Inventors: Edwin Mauricio Hincapie Montoya, Medellin (CO); Juan Sebastian Maya, Medellin (CO); Christian Andres Diaz Leon, Medellin (CO)

(21) Appl. No.: 16/340,565

(22) PCT Filed: Feb. 6, 2018
(86) PCT No.: PCT/IB2018/050729

§ 371 Date: Apr. 9, 2019

(30) Foreign Application Priority Data
Jun. 27, 2017 (CO) NC2017/0006563

(51) Int. Cl. A61G 1/04; E05C 19/16

(52) U.S. Cl. CPC A61G 1/04; A61G 1/013; E05C 19/16

(57) ABSTRACT

The present invention relates to an automatic lock mechanism for foldable systems, where such lock mechanism is used with any kind of foldable system, such as a stretcher that consists of a plurality of panels, where the intelligent lock of each foldable panel is made by a measurement system that determines when the folds are in the desired position, this is, parallel to one another or one after the other, and an electronic lock system that triggers a magnetic lock when panels reach the desired position to create a stiff element from the panels comprising the foldable system.

### TECHNICAL FIELD

The present invention relates to an automatic lock mechanism for foldable systems, where such lock mechanism is used with any kind of foldable system, such as a stretcher that consists of a plurality of panels, where the intelligent lock of each foldable panel is made by a measurement system that determines when the folds are in the desired position, this is, parallel to one another or one after the other, and an electronic lock system that triggers a magnetic lock when panels reach the desired position to create a stiff element from the panels comprising the foldable system.

### BACKGROUND OF THE INVENTION

Currently, foldable elements have become a growing need, since they allow obtaining larger elements in reduced space and locate them in short spaces such as vehicles, bag packs or any elements for make easier their transportation. However, these foldable elements always have problems of stability when used, since the elements that allow joining the folds are not appropriate because they are pulse mechanical elements that have a pin or alike into a hole or borehole to keep the panels or foldable parts in position.

Additionally, it is important to say that the lock is always made manually, this is, the constant manipulation by the user is required, which in some cases is inconvenient due to bumps or pinches in the user's fingers that may cause minor but uncomfortable injuries.

Thus, in the state of the art there are several claims related to this type of mechanisms, such as document U.S. Pat. No. 4,799,274 that describes a stretcher system with two longitudinal profiles supporting a stretcher sheet to create a rigid structure to transport persons for attention, where such profiles have supports with foldable transversal stiffening members that fold, such supports have openings for receiving a leg member and the supports are secured by clamping screws.

On the other hand, there is document WO 2012/042074, which claims a foldable stretcher comprising two parallel bars connected by means of foldable cross members an on which the opposing sides of a piece of fabric shaped as a surface for supporting the patient are fixed and straps, where each bar consists of four tube sections joined by hinges that form a U-shaped section with lower cut-outs.

Likewise, document GB 2243289 describes a foldable seat comprises a plurality of pairs of hinged plates that are coupled together on a hinge axis, the plates being pivotable about the hinge axis between two extreme positions, one folded and one extended. The disposition of the hinge axis relative to the plates and the dimensions of the plates being such that the plates cannot subtend between them an opening angle which is greater than 180°. The 1.0 panels or plates can be locked with a lock system allowing to keep their position.

Likewise, prior U.S. Pat. No. 5,240,276 claims a foldable wheelchair having a light weight construction using an interlocking mechanism between the individual parts to provide a wheelchair of improved structural stability without a separate frame assembly. The wheelchair comprises molded panels, which are interchangeable, and support elements, also interchangeable, the entire assembly being connected together by means of interlocking buttons and pin or rods. The interlocking connector of the wheelchair elements comprises an elongated shaft having width and thickness dimensions at one end thereof a head, said head having a flange extending laterally beyond the perimeter of such shaft, the end of said shat opposite said head having a channel through the width of the shaft.

On the other hand, WO 2006044634 describes a collapsible wheelchair frame having left and right side plates, each having an upper end and a lower end with left and right seat plates, where each seat plate having distal and proximal ends, where the proximal ends of the seat plates, and the distal end of the left seat plate are hingedly attached to the distal end of the right seat plate, and left and right brace plates where each brace plate has proximal and distal ends hingedly attached to the side plates. In a modality, the frame may have lock means to lock the position of the plates in the desired manner an angle.

Finally, document CN 203925014, describes a lock mechanism with double fail-safe system, comprising an L-shaped lock piece, a magnet, a hinge rod, springs, springs attachment points, a semicircular rod, a button, a lock sealing and alike. This way, when the lock mechanism closes, an inclined plane of 45° on the frontal flange of the lock sealing compresses an inclined plane 45° on the frontal flange of the lock sealing, after the compression is made from certain distance, the lock piece may completely enter into the lock body, and this way the lock piece may be tightly attracted by the magnet by means of magnetic force, and the lower portion of the lock piece may be interlocked through the lock closing in such a way that a double lock piece is formed and avoids that the lock piece does not fall from the lock box.

From the above information, a skilled person may clearly see that in the current state of the art there are several lock systems for foldable systems, such as foldable wheelchairs, comprising in most cases, panels, where these foldable systems have any kind of lock system to secure panels or plates in a specific position to use the apparatus with any problems. Likewise, there is a claim related to a lock mechanism that may be used in any devices or apparatus, without limiting the foldable elements or alike.

However, a skilled person may also note that there is not a single document or claim in the state of the art suggesting or describing an automatic lock system, which has tilt sensors and an electronic mechanism allowing activating a magnetic sub-system to secure the foldable panels to be locked in the desired position and this way, to secure the apparatus stability where such mechanism is installed, according to the needs of use of such device.

Accordingly, it is clear that the claims existing in the state of the art only relate to lock systems which are completely mechanic, this is, without electronic components or sensors that allow a much more accurate and precise operation, which is indispensable, and it is a technical field where we haven't seen many advances in the past years, which allows indicating that there is a need from many years ago that has not been successfully supplied.

According to the above, it is clearly seen that there is a problem related to a lock of foldable systems, especially in systems used in a person's health, being necessary to ensure a structure that allows a totally flat surface, without gaps, to carry out a procedure or to transport a patient or person. Additionally, the lock systems or hinges currently existing do not allow assembling or disassembling the foldable system in a rapid and reliable manner, but they rely on an operator, which is subject to human error.

Therefore, it is also observed that in the state of the art there is a need for designing and implementing a totally automatic lock device or mechanism and at the same time constant control or monitoring elements to secure the position of the foldable element to be installed and used with elements that may help to the person's health or live-saving, such as a foldable stretcher or alike.

According to the above, the present invention solve the problem in a more efficient manner, since it is a lock mechanism for foldable systems that allows the intelligent lock of each foldable panels, by means of a measurement system that determines when folds are in the desired position, this is, parallel to one another, and an electronic lock system that when panels reach their desired position, triggers a magnetic lock to create a stiff unit from the panels comprising the foldable system. Particularly, the automatic lock mechanism of the present invention allows obtaining an improved result compared to the state of the art, and it solves the problem mentioned above, based on a series of accelerometers that measure the folds angles of the foldable system where it is installed and a lock electromagnetic mechanism.

### SUMMARY OF THE INVENTION

The present invention relates to an automatic lock mechanism to be used or applied to foldable elements, which allows an intelligent lock of each one of the foldable panels by means of a measurement system that determines when folds are in the desired position, this is, parallel to one another, y un electronic lock system that when panels reach their desired position, triggers un magnetic lock to create a stiff unit from the panels comprising the foldable system. Particularly, the automatic lock mechanism of the present invention allows obtaining an improved result compared to the state of the art and that solves the problem mentioned above, based on a series of accelerometers that measure the folds angles of the foldable system where it is installed and a lock electromagnetic mechanism.

Thus, the electromagnetic mechanism secures the lock mechanism and allows that the panels of the foldable system on which such mechanism is installed, lock in their position in a safe manner, and because electric power is required for its functioning, it do not return to its original position, this is, is does not unlock unless it receives the command, which secures the position of the system's panels or foldable elements.

### BRIEF DESCRIPTION OF DRAWINGS

The present invention is better understood from the following drawings that show its parts and components and the novelty features that differentiate it from the state of the art.

FIG. 1 shows a general perspective view of the lock mechanism of the present invention.

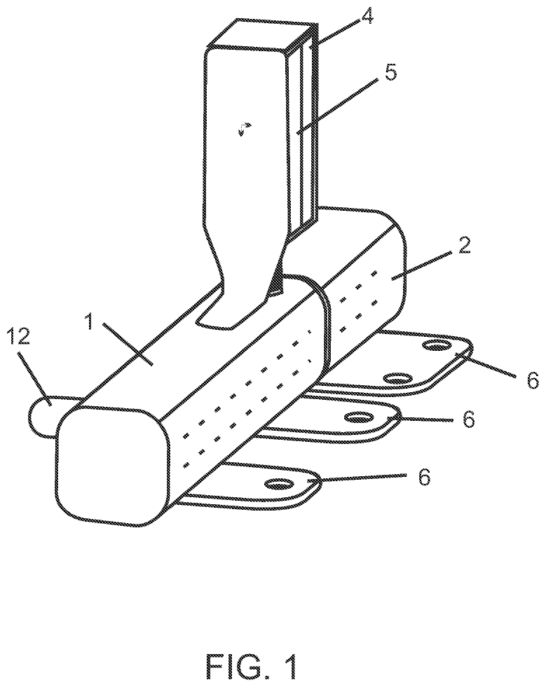

FIG. 2 shows another perspective view of the lock mechanism of the invention from the front.

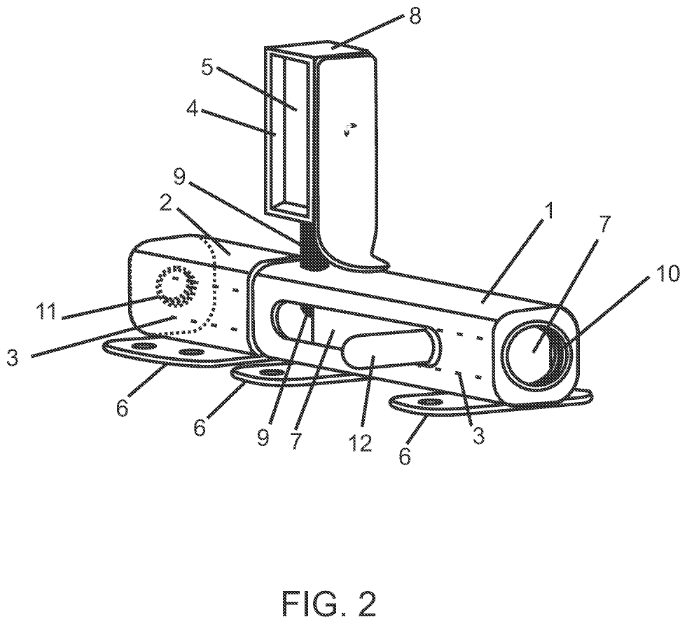

FIG. 3 shows a plane upper view of the mechanism of the present invention.

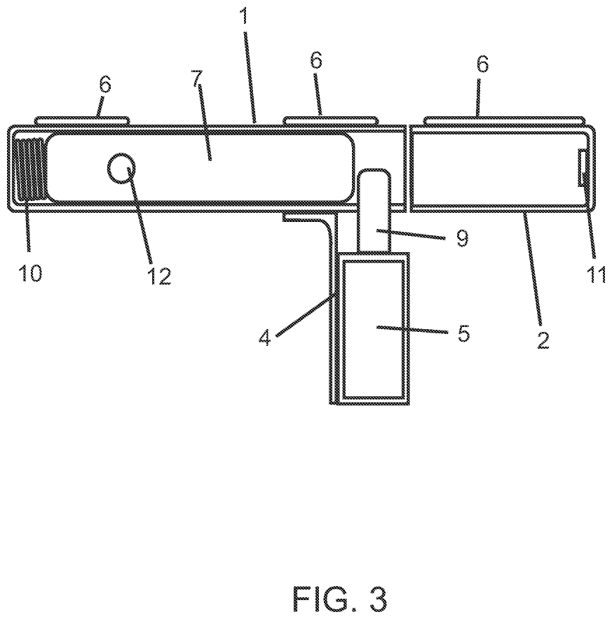

### DETAILED DESCRIPTION OF THE INVENTION

The present invention relates to a lock mechanism to be used in any type of foldable element or that require a safe and appropriate lock, which is characterized for comprising the following components or parts:
A long liner (1), which is the element that internally hosts most of the pin (7) or lock system magnetically and electronically (8) aided when unlocked the panels system, in that liner (1) one of the panels comprising the foldable system is assembled and the whole lock mechanism is installed;
A short liner (2), which assembles the panel opposite to the long liner (1) assembly of the foldable system, and that hosts the pin when the system is locked;
Tilt sensors (3), that are accelerometers, inertial tracking units or other kind of sensors that allow measuring the direction of the panels on which the short liner (2) and the long liner (1) are assembled. Where said tilt sensors activate the pin (4) when they determine that the short liner (2) and the long liner (1) are parallel;
A pin (4), that blocks the foldable system through magnetic or electronic (8) aid, where the electronic component comprises the tilt sensors (3) that send to a solenoid (5) a signal when the tilt angle between the panels is about 0°, in such a way that this solenoid (5) hosts the perpendicular rod (9), which causes that the pin (7) with compressed spring (10) in one end passes from being hosted in the long liner (1) to be between the long liner (1) and the short liner (2),resulting in the lock of the whole mechanism;
Magnets (11) located on the opposite end of the pin (7) spring (10), which keep the pin on its lock position while the panels are almost in parallel position the one to the another; and
A base (6) to join the panels of the foldable system where the installation of the automatic lock element is made, being such base (6) located on the lower part of the long liner (1) and the short liner (2) and it divides into a plurality of section to join the system more appropriately.

Thus, the lock mechanism of the present invention functions with a plurality of tilt sensors (3) allowing determining when the foldable panels of the foldable system where it is installed, are in the appropriate position and they keep in a locked or unlocked position, where such lock is made by means of a series of magnets (11) on the long liner (1) and the short liner (2) ends.

On the other hand, to unlock the system, the user manually pulls the pin (7) by a lever (12) that corresponds to the lock mechanism, to put the pin back on the long liner (1) and cause that the perpendicular rod (9) returns to its original position.

1. An automatic lock mechanism for foldable systems, characterized in that it consists of:
a long liner (1) that host the most of pin (7) or lock system with magnetic and electronic (8) aid;
a short liner (2);
tilt sensors (3) located on both long liner (1) and short liner (2);
a pin or lock system (4) with electronic and magnetic aid components;
magnets (11) located on the opposite end of the pin (7) spring (10); and
a join base (6) on the lower part of the long liner (1) and the short liner (2).

2. The lock mechanism according to claim 1, characterized in that the long liner (1) attaches to one of the panels composing the foldable system.

3. The lock mechanism according to claim 1, characterized in that the short liner (2) locates on the panel opposite to the long liner (1) in the foldable system.

4. The lock mechanism according to claim 1, characterized in that the tilt sensors (3) are chosen from a group consisting of accelerometers, inertial tracking units and direction measurement sensors.

5. The lock mechanism according to claim 1, characterized in that the electronic component of the pin or lock system (4) comprises of solenoid (5) with perpendicular rod (9) and tilt sensors (3) connected to each other.

6. The lock mechanism according to claim 1, characterized in that the pin or lock system (4) has a compressed spring on one end.

7. The lock mechanism according to claim 1, characterized in that the join base (6) is divided into sections.
